(19) United States
(12) Patent Application Publication
(10) Pub. No.: US 2025/0216034 A1
(43) Pub. Date: Jul. 3, 2025

(54) ADSORBENT-TYPE STORAGE AND DELIVERY VESSELS WITH HIGH PURITY DELIVERY OF GAS, AND RELATED METHODS

(71) Applicant: ENTEGRIS, INC., Billerica, MA (US)

(72) Inventors: Joseph R. Despres, Middletown, CT (US); Joseph Sweeney, New Milford, CT (US); Edward A. Sturm, New Milford, CT (US)

(21) Appl. No.: 19/082,110

(22) Filed: Mar. 17, 2025

Related U.S. Application Data
(63) Continuation of application No. 17/505,735, filed on Oct. 20, 2021.
(60) Provisional application No. 63/104,966, filed on Oct. 23, 2020.

(51) Int. Cl. F17C 11/00; B01D 53/02; B01J 20/20; B01J 20/30

(52) U.S. Cl. CPC F17C 11/00; B01D 53/02; B01J 20/20; B01J 20/3078; B01D 2259/4525; F17C 2265/01

(57) ABSTRACT

Described are storage and dispensing systems and related methods, for the storage and selective dispensing germane a reagent gas from a vessel in which the reagent gas is held in sorptive relationship to a solid adsorbent medium at an interior of a storage vessel and wherein the methods and dispensing systems provide dispensing of the reagent gas from the storage vessel with a reduced level of atmospheric impurities contained in the dispensed reagent gas.

### CROSS-REFERENCE TO RELATED APPLICATIONS

This application is a continuation of U.S. patent application Ser. No. 17/505,735, filed Oct. 20, 2021, which claims the benefit under 35 USC 119 of U.S. Provisional Patent Application No. 63/104,966, filed Oct. 23, 2020, the disclosure of which is hereby incorporated herein by reference in its entirety.

### FIELD

The invention relates to storage and dispensing systems, and related methods, for storing and selectively dispensing high purity reagent gas from a storage vessel in which the reagent gas is held in sorptive relationship to a solid adsorbent medium.

### BACKGROUND

Gaseous raw materials (referred to sometimes as “reagent gases”) are used in a range of industries and industrial applications. Some examples of industrial applications include those used in processing semiconductor materials or microelectronic devices, such as ion implantation, expitaxial growth, plasma etching, reactive ion etching, metallization, physical vapor deposition, chemical vapor deposition, atomic layer deposition, plasma deposition, photolithography, cleaning, and doping, among others, with these uses being included in methods for manufacturing semiconductor, microelectronic, photovoltaic, and flat-panel display devices and products, among others.

In the manufacture of semiconductor materials and devices and various other industrial processes and applications, there is ongoing need for reliable sources of highly pure reagent gases. Examples of reagent gases include silane, germane (GeH₄), ammonia, phosphine (PH₃), arsine (AsH₃), diborane, stibine, hydrogen sulfide, hydrogen selenide, hydrogen telluride, halide (chlorine, bromine, iodine, and fluorine) compounds, among others. Many of these gases must be stored, transported, handled, and used with a high level of care and with many safety precautions, such as, optionally, a storage vessel that contains a reagent gas at sub-atmospheric pressure.

A variety of different types of containers are used to contain, store, transport, and dispense reagent gases for industrial use. Some containers, referred to herein as “adsorbent-based containers,” contain a gas using a porous adsorbent material included within the container, wherein the reagent gas is stored by being adsorbed onto the adsorbent material. The adsorbed reagent gas may be contained in the vessel in equilibrium with an added amount of the reagent gas also present in condensed or gaseous form in the container, at sub-atmospheric or super-atmospheric pressure.

The gaseous raw material must be delivered for use in a concentrated and substantially pure form and must be available in a packaged form that provides a reliable supply of the gas for efficient use of the gas in a manufacturing system.

Various process steps and techniques have been described for generally reducing amounts of impurities contained within an adsorbent-based storage system when preparing the system for use. See, patent publication WO 2017/079550.

Current commercial adsorbent-type storage systems contain many varieties of highly pure reagent gas for selective delivery from the vessel. These storage systems can deliver reagent gases that contain relatively low levels of impurities, such as amounts of atmospheric impurities (nitrogen (N₂), carbon monoxide (CO), carbon dioxide (CO₂), methane (CH₄), and water vapor (H₂O)) that are below 10,000 ppmv (parts per million based on volume), measured as a total amount of nitrogen (N₂), carbon monoxide (CO), carbon dioxide (CO₂), methane (CH₄), and water vapor (H₂O). For some reagent gases the total amount of these atmospheric impurities may be as low as 5,000 ppmv, and for other reagent gases the amount may be as low as 500 ppmv. But there remains ongoing need for improved adsorbent-type storage systems that deliver reagent gas that contains increasingly lower levels of impurities.

Based on current and previous commercial methods of preparing adsorbent-type storage and delivery systems, suppliers of these products have not developed methods and techniques to process and assemble commercially available storage systems that achieve significantly lower levels of atmospheric impurities, including levels of total atmospheric impurities that are well below 500 ppmv (“total atmospheric impurities” being measured as a total (combined) amount of nitrogen (N₂), carbon monoxide (CO), carbon dioxide (CO₂), methane (CH₄), and water vapor (H₂O)).

### SUMMARY

In one aspect, the invention relates to adsorbent-type storage systems that contain reagent gas and adsorbent. The system includes a storage vessel that includes an interior, adsorbent at the interior, and reagent gas adsorbed on the adsorbent. The system is capable of dispensing reagent gas from the vessel with the dispensed reagent gas containing less than 150, 50, 25, or 10 parts per million (volume) (ppmv) of a total amount of impurities selected from CO, CO₂, N₂, CH₄, and H₂O, and combinations thereof.

In another aspect, the invention relates to a process for storing reagent gas in a vessel that contains adsorbent. The process includes providing adsorbent; placing the adsorbent at an interior of a vessel and exposing the adsorbent at the vessel interior to elevated temperature and reduced pressure. to remove residual moisture and volatile impurities. After exposing the adsorbent at the vessel interior to elevated temperature and reduced pressure, reagent gas is added to the vessel interior. The reagent gas becomes adsorbed onto the adsorbent and is contained in the vessel at a pressure below atmospheric pressure. The reagent gas is stored within the vessel and can be selectively dispensed from the vessel, with the dispensed reagent gas containing less than 150 parts per million of a total amount of impurities selected from CO, CO₂, N₂, CH₄, and H₂O, and combinations thereof.

### BRIEF DESCRIPTION OF THE DRAWINGS

FIG. 1 illustrates a multi-reagent gas system for filling multiple different reagent gases to storage vessels.

FIG. 2 shows an example storage system of the present description.

The Figures are schematic, illustrative, non-limiting, and not necessarily to scale.

### DETAILED DESCRIPTION

The present disclosure relates to storage systems for storing reagent gas on an adsorbent material within an enclosed vessel, for selectively dispensing the reagent gas from the vessel. The systems are useful as a reversible storage and dispensing system for reagent gas that allows for reagent gas that is stored on the adsorbent, within the vessel, to be selectively desorptively dispensed (delivered) from the vessel under fluid dispensing conditions. The systems are able to dispense any of various reagent gases from the vessel, with the delivered reagent gas containing a comparably low amount of atmospheric impurities, e.g.: a low amount of one or more of: nitrogen (N₂), carbon monoxide (CO), carbon dioxide (CO₂), methane (CH₄), and water vapor (H₂O), individually; and a low total (combined) amount of these impurities measured together.

The disclosure also describes various steps or techniques that can be used to prepare and assemble a storage system as described, that contains reagent gas stored on adsorbent contained in a vessel. Useful steps of preparing and assembling the storage system to contain adsorbent and reagent gas stored in a vessel will reduce the amount of impurities (compared to comparable non-inventive storage systems) that will be present within the vessel that contains adsorbent and adsorbed reagent gas, and, subsequently the amount of impurities that will be present in a reagent gas as the reagent gas is delivered from a storage vessel.

Generally, example methods as described relate to processes for storing reagent gas in a vessel that contains adsorbent. An example process includes providing adsorbent; placing the adsorbent at an interior of a vessel; and exposing the adsorbent at the vessel interior to elevated temperature and reduced pressure to desorb and remove trace level atmospheric impurities that may have been adsorbed upon or within the porous adsorbent media during handling and package construction.

Various other optional treatments of the adsorbent may be conducted in-situ (within the vessel), prior to adding reagent gas to the adsorbent-filled container, to reduce the amount of atmospheric impurities that will be present in the reagent as the reagent gas is discharged from the vessel after storage. For example, a useful optional step may be to chemically passivate the porous adsorbent of active surface sites that could react with the particular reagent gas to be stored. Details of such treatments are dependent on the specific adsorbent that is used and the specific type of reagent gas to be adsorbed, stored, transported and delivered using the vessel and adsorbent. Such treatments may include physical or chemical means for neutralizing Lewis acid or base sites.

Still generally, after exposing the adsorbent at the vessel interior to elevated temperature and reduced pressure, or any additional or alternate in-situ processing, reagent gas is added to the vessel interior to cause or allow the reagent gas to become adsorbed onto the adsorbent and to become contained in the vessel for storage and selective delivery (discharge) from the vessel. The reagent gas may be added and contained within the vessel at any pressure, such as a super-atmospheric pressure or a sub-atmospheric.

The reagent gas can be stored over a useful period of time within the vessel and selectively dispensed (discharged, delivered) from the vessel for use, with the dispensed reagent gas containing, for example, less than 150 parts per million (by volume) of a total amount of impurities selected from CO, CO₂, N₂, CH₄, and H₂O, and combinations thereof, e.g., the dispensed reagent gas may contain a total amount of these impurities that is below 50, 25, 15, or 10 ppmv.

Alternately or additionally, reagent gas as discharged can contain individually low amounts of each of one or more of the individual impurities selected from CO, CO₂, N₂, CH₄, and H₂O, and combinations thereof. For example, the dispensed reagent gas may contain less than 25, 20, 15, 10, or 5 ppmv of any one of these impurities. Alternately or additionally a dispensed reagent gas may contain less than 25, 20, 15, 10, or 5 ppmv of two or more different components each measured individually, e.g., less than 25, 20, 15, 10, or 5 ppmv, measured individually, of a combination of two or more of CO, CO₂, N₂, CH₄, and H₂O.

Conventionally, purity of reagent gas contained in adsorbent-type storage systems has been measured, monitored, and described in terms of the purity of reagent gas that is initially added to a vessel for storage, i.e., the purity of the reagent gas before the reagent gas is charged to the storage vessel for storage within the vessel. However, depending on the type of storage vessel, adsorbent, and their preparation and assembly, this measure of purity may not be representative of the purity of the reagent gas stored and delivered from a vessel.

Zeolites contain metals and oxides that can also interact with various reagent gases, and are also known to have high affinity for atmospheric moisture and contaminants. Metal organic frameworks (MOFs), by definition, incorporate metal ions and clusters, primarily transition metals, which can interact irreversibly with an adsorbed reagent gas species. The syntheses of these specialty adsorbents also use reactive organic ligands and solvents that can be left behind in low levels within the pore structure of crystalline MOF structures, only to react or interact later with an adsorbed reagent gas. Therefore, it is becoming increasingly non-representative to define the purity of a delivered reagent gas, after adsorption onto porous storage media, storage, and transportation, by the purity analysis of the starting gas.

Moreover, users of stored reagent gases continue to require higher and higher levels of purity of reagent gases, including ever lower levels of atmospheric impurities that may be introduced to a storage vessel as part of a component of the storage vessel (e.g., adsorbent or vessel), or that may be introduced during assembly, filling, or handling of the vessel or a component of the vessel.

The present description relates to methods of controlling or reducing the amount of impurities, especially (but not exclusively) atmospheric impurities, that are present in an adsorbent-type storage system, or in a system and equipment that is used to supply reagent gas to an adsorbent-type storage system, and that may be transferred to reagent gas stored in and delivered from the adsorbent-type storage system. According to the description, purity of reagent gases stored in an adsorbent-containing vessel can be measured not at the point of the reagent gas being added to the storage vessel to initially fill (charge) the storage vessel but can instead be measured as the reagent gas is delivered (dispensed, discharged) from the vessel.

According to the present description, steps and techniques that can be used for preparing, handling, and assembling components of the adsorbent-type storage system are performed in a manner to remove atmospheric impurities from components of the storage system, or to reduce or prevent exposure of the components of the storage system (especially the adsorbent) to atmospheric gases (“atmospheric impurities”) such as nitrogen (N₂), carbon monoxide (CO), carbon dioxide (CO₂), methane (CH₄), and water vapor (H₂O). Useful methods reduce the amounts of these atmospheric impurities that are present in a storage vessel (including adsorbent), in a system for adding reagent gas to a storage vessel, or both, to desirably reduce the amounts of these atmospheric impurities that are present in a reagent gas as the reagent gas is eventually dispensed from the storage vessel.

A storage system as described includes a vessel that contains adsorbent material at its interior. The adsorbent material is effective to contain, store, and deliver reagent gas from the storage vessel. The reagent gas is adsorbed on the adsorbent and is present as a gas at the vessel interior, with a portion of the reagent gas being adsorbed by the adsorbent, and another portion being in gaseous form or condensed and gaseous form and in equilibrium with the adsorbed portion. The reagent gas can be initially charged into the vessel to a desired (e.g., maximum) capacity of reagent gas relative to the adsorbent, based on a desired initial storage pressure within the vessel, which may be a sub-atmospheric pressure (below 760 Torr) or a super-atmospheric pressure (the initial storage pressure is referred to as a “use pressure” or a “target pressure” of a fill step after equilibration of an initial amount of reagent gas, see below). The reagent gas becomes adsorbed onto the adsorbent for storage and is present as a gaseous or condensed form in equilibrium with the adsorbed reagent gas. Subsequently, the gas can be selectively delivered (dispensed) from the vessel for use by exposing the adsorbent and adsorbed reagent gas at the vessel interior to dispensing conditions.

As used herein, the term “dispensing conditions” means one or more conditions that are effective to desorb reagent gas held in a vessel with adsorbent, so that the reagent gas disengaged from the adsorbent on which the reagent gas has been adsorbed, and so the disengaged reagent gas is dispensed from the adsorbent and the vessel, for use. Useful dispensing conditions may include conditions of temperature and pressure that cause reagent gas to desorb and be released by the adsorbent, such as: heating the adsorbent (and a vessel that contains the adsorbent) to effect thermally-mediated desorption of the reagent gas; exposing the adsorbent to a reduced pressure condition to effect pressure-mediated desorption of the reagent gas; a combination of these; as well as other effective conditions.

The pressure (initial “use” pressure) at the interior of the vessel may be sub-atmospheric, meaning below about 760 Torr (absolute), or may be super-atmospheric. For sub-atmospheric storage, during storage of the vessel, or during use of the vessel to store and dispense reagent gas, the pressure at the interior of the vessel may be below 760 Torr, e.g., below 700, 600, 400, 200, 100, 50, 20 Torr, or even a lower pressure. For super-atmospheric storage, during storage of the vessel, or during use of the vessel to store and dispense reagent gas, the pressure at the interior of the vessel may be in a range from about 760 to 50,000 Torr, e.g., from about 1,000 to about 30,000 Torr.

The described vessels and methods can be useful for storing, handling, and delivering any reagent gas that may be stored as described, at equilibrium between an adsorbed portion and a condensed or gaseous portion. A vessel as described can be particularly desirable for storing a reagent gas that is hazardous, noxious, or otherwise dangerous. Illustrative examples of reagent gases for which the described vessels and methods are useful include the following non-limiting examples: silane, methyl silane, trimethyl silane, hydrogen, methane, nitrogen, carbon monoxide, arsine, phosphine, phosgene, chlorine, BCI₃, BF₃ (including isotopically enriched materials), diborane (B₂H₆, including its deuterium analog), tungsten hexafluoride, hydrogen fluoride, hydrogen chloride, hydrogen iodide, hydrogen bromide, germane, ammonia, stibine, hydrogen sulfide, hydrogen cyanide, hydrogen selenide, hydrogen telluride, deuterated hydrides, trimethyl stibine, halide (chlorine, bromine, iodine, and fluorine), gaseous compounds such as NF₃, CIF₃, GeF₄ (including isotopically enriched materials), SiF₄, AsF₃, PF₃, organo compounds, organometallic compounds, hydrocarbons, organometallic Group V compounds such as (CF₃)₃Sb, and other halide compounds that include boron halides (e.g., boron triiodide, boron tribromide, boron trichloride), germanium halides (e.g., germanium tetrabromide, germanium tetrachloride), silicon halides (e.g., silicon tetrabromide, silicon tetrachloride), phosphorus halides (e.g., phosphorus trichloride, phosphorus tribromide, phosphorus triiodide), arsenic halides (e.g., arsenic pentachloride), and nitrogen halides (e.g., nitrogen trichloride, nitrogen tribromide, nitrogen triiodide). Reagent gas contained in a vessel and adsorbed on adsorbent can also include a combination of two or more gases, for example a combination of hydrogen gas with a fluorine-containing gas such as boron trifluoride or germanium tetrafluoride. For each of these compounds, all isotopes are contemplated.

The methods and techniques of reducing levels of impurities in an adsorbent-based storage system may be effective for reducing impurities contained in various types of adsorbent materials, and do not depend on the specific type or composition of the adsorbent. Any of various types of adsorbent materials may be useful with and may benefit from methods as described herein to reduce the presence of impurities in an adsorbent-type storage system, and to reduce the amount of atmospheric impurities that are present in a reagent gas that is stored using the adsorbent.

Example adsorbents include adsorbent materials selected from carbon-based materials (e.g., activated carbon), silicalites, metal organic framework (MOF) materials (including zeolitic imidazolate frameworks), polymer framework (PF) materials, zeolites, porous organic polymers (POP), covalent organic frameworks (COF), as well as others. Adsorbent may be in any size, shape, or form, such as granules, particulates, beads, pellets, or shaped monoliths.

Certain examples of adsorbent materials are mentioned in U.S. Pat. Nos. 5,704,967, 6,132,492, and PCT patent publication WO 2017/008039, PCT patent publication WO 2017/079550, the entireties of each of these being incorporated herein by reference.

Metal-organic frameworks include generally highly porous materials made from organic linkers coordinated to metal ion or metal oxide clusters in crystalline structures. Various classes of MOFs are known, and include: ZIF-like MOFs (Zeolitic Imidazole Frameworks); MILs (Material Institut Lavosisier) MOF materials (e.g. MIL-100); IRMOF-like Materials (e.g. IRMOF-1); M-MOF-74/CPO-27-M-like paddlewheel MOFs, (where M may be Zn, Fe, Co, Mg, Ni, Mn, or Cu); Zn oxide node frameworks; DMOF-like MOF materials (e.g. DMOF-1), as well as others.

One class of MOF that is useful or preferred as an adsorbent is the class of zeolitic imidazolate frameworks, or “ZIFs.” Zeolitic imidazolate frameworks are a type of MOF that includes a tetrahedrally-coordinated transition metal such as iron (Fe), cobalt (Co), nickel (Ni), copper (Cu), magnesium (Mg), manganese (Mn) or zinc (Zn), connected by imidazolate linkers, which may be the same or different within a particular ZIF composition or relative to a single transition metal atom of a ZIF structure. The ZIF structure includes four-coordinated transition metals linked through imidazolate units to produce extended frameworks based on tetrahedral topologies. ZIFs are said to form structural topologies that are equivalent to those found in zeolites and other inorganic microporous oxide materials.

A variety of carbon materials are useful as adsorbents. They include: carbon formed by pyrolysis of synthetic hydrocarbon resins such as polyacrylonitrile, sulfonated polystryrene-divinylbenzene, polyvinylidene chloride, etc.; cellulosic char; charcoal; activated carbon formed from natural source materials such as coconut shells, pitch, wood, petroleum, coal; nanoporous carbon, etc.

One particular example of a carbon adsorbent (nanoporous carbon) is a carbon pyrolyzate of polyvinylidene chloride (PVCD) polymer or copolymer, which may be formed to a pyrolyzate that has pore (slit) sizes between 0.5 and about 1 nm, and may have a high density (e.g., on the order of approximately 1.1 g/cc), with a large micropore volume (>40%, with macropores (>5 nm) and void volume being only on the order of 10%), and a high surface area (e.g., about 1,100 m²/g). At a microscopic level, such nanoporous carbon materials consist of graphene sheets (sp2 hybridized graphite planes) that are folded and interleaved in a somewhat random orientation, yielding relatively high electrical and thermal conductivities. See WO 2017/079550, the entirety of which is incorporated herein by reference.

A useful or preferred carbon adsorbent may be of a type and character that is substantially pure before being placed into a vessel as adsorbent in a system as described. Purity of effective carbon adsorbent material may be characterized in terms of ash content of the carbon. For example, a useful or preferred carbon adsorbent may contain not more than 0.01 weight percent ash content, as measured by a standard test, for example as measured by ASTM D2866-83 or ASTM D2866.99. Carbon purity may preferably be at least 99.99 percent as measured by a Particle Induced X-ray Emission technique (PIXE).

According to the present description, one or more of various steps may be performed on an adsorbent, on a vessel to contain adsorbent as part of a storage system, or during assembly (including a step of filling a vessel with reagent gas) of a storage system, to reduce amounts of atmospheric impurities that will be present in the vessel, adsorbent, and reagent gas during storage and delivery of the reagent gas. A reduction in the amount of atmospheric impurities will be present in the reagent gas as the reagent gas is stored within and is delivered from the vessel, after a period of typical storage of the reagent gas within the vessel. A typical period of storage (at ambient temperature, 25 degrees Celsius) of a system as described, including a vessel with contained adsorbent and reagent gas, may be a period of weeks (e.g., 1, 2, 6, or 8 weeks) or a period of months (e.g., 3, 6, 9, or 12 months), during and after which a useful or preferred system is capable of delivering reagent gas that contains relatively low levels of atmospheric impurities as described, e.g., compared to alternative storage systems.

As one technique for reducing the presence of impurities in a storage system, particularly impurities contained by an adsorbent, an adsorbent may be processed by a pyrolysis step that will reduce an amount of impurities contained by the adsorbent. A pyrolysis step may be performed before the adsorbent is added to a vessel and may be performed on any adsorbent that is sufficiently thermally stable to withstand heating conditions of a pyrolysis step. Examples of adsorbents that can withstand pyrolysis include carbon-based adsorbents.

A pyrolysis step, generally, refers to a step of thermal decomposition in an oxygen-free environment. Pyrolysis may be performed by exposing adsorbent to any suitable pyrolysis conditions, and, as desired or useful, may be carried out in progressive fashion involving temperature ramping from an ambient starting temperature to a desired elevated pyrolysis temperature, e.g., in a temperature range of from 600° C. to 1000° Celsius. An amount of time for a pyrolysis processing step may be any effective amount of time, for example a total time in a range from 1 to 7 days, or longer, as desired. The atmosphere in which the pyrolysis step may be performed can be an inert atmosphere that is free of oxygen, carbon monoxide, carbon dioxide, and moisture. Example atmospheres include nitrogen, argon, and forming gas (a mixture of 5 percent hydrogen in nitrogen). See WO 2017/079550, United States Patent Publication 2020/0206717, the entirety of which is incorporated herein by reference.

Following a pyrolysis step, adsorbent that has been processed by pyrolysis may contain a level of atmospheric impurities that is below about 50, 40, or 20 ppmv for each of: nitrogen (N₂), carbon monoxide (CO), carbon dioxide (CO₂), methane (CH₄), and water vapor (H₂O), measured individually. The adsorbent may contain less than 70, 60, or 50 ppm of a total amount of nitrogen (N₂), carbon monoxide (CO), carbon dioxide (CO₂), methane (CH₄), and water vapor (H₂O), combined (in total) for all of these impurities.

Following pyrolysis of adsorbent that can withstand pyrolysis temperatures or following another step of preparing other types of adsorbent, useful methods of preparing a storage system as described, with reduced levels of atmospheric impurities, can include steps and techniques for handling adsorbent in a manner that prevents exposing the adsorbent to atmospheric gases before and as the adsorbent is placed in a storage vessel (e.g., following pyrolysis).

As one example, to reduce or prevent exposure of adsorbent to atmospheric impurities after a pyrolysis step and before placing the pyrolyzed adsorbent in a storage vessel, adsorbent that is subject to pyrolysis (e.g., carbon-type adsorbent that is pyrolyzed) may be placed into a storage vessel directly after a pyrolysis step. For example, pyrolyzed adsorbent can be packaged or loaded directly into a vessel (container of a storage system) (or alternately a pre-package such as a gas-impermeable bag) without being exposed to ambient environment, via direct filling within a dry, inert (e.g., nitrogen atmosphere), purged containment system. Adsorbent material may be moved through isolation gates from a pyrolysis furnace directly into a package (e.g., vessel, cylinder, or gas-impermeable bag, in a controlled environmental). Media may be loaded into the package while within a controlled atmosphere (e.g., dry nitrogen with optionally cooling of the surrounding environment to reduce moisture content in the atmosphere), with no exposure to ambient atmosphere (i.e., air), and within a short amount of time after the pyrolysis step, such as within 30 minutes after an end of a pyrolysis step. Because adsorption capacity of the adsorbent is reduced at elevated temperature, the adsorbent media may be transferred from a pyrolysis step to a package, in a short amount of time (e.g., under 30, 20, or 10 minutes) while at elevated temperature of between 40 degrees Celsius and 65 degrees Celsius, and optionally within a dry, oxygen-depleted (e.g., containing less than 1, 0.5, or 0.1 volume percent oxygen) environment (e.g., concentrated nitrogen). In various example methods that use the same atmosphere and timing, the media may be directly loaded into a storage vessel (e.g., cylinder) or into a different package such as a gas-impermeable package (e.g., a “gas-impermeable bag”) (See WO 2017/079550). If a temporary gas impermeable package is used, that package may also contain optional desiccant material, oxygen scavenger, or both, to further protect the media until the media is transferred to the storage vessel.

According to such a step, a pyrolyzable adsorbent may be subject to a pyrolysis step in a pyrolysis furnace, to form a pyrolyzed adsorbent. The pyrolyzed adsorbent may be discharged from the pyrolysis furnace at a discharge locus, and the pyrolyzed adsorbent may be directly placed into a storage vessel at the discharge locus, e.g., delivered to an interior of a gas storage and dispensing vessel. See WO 2017/079550, United States Patent Publication 2020/0206717. These steps may be carried out in a fabrication facility that includes an enclosure that contains the pyrolysis furnace. The enclosure may additionally contain (enclose) an adsorbent fill station at the discharge locus of the pyrolysis furnace, with the adsorbent fill station being arranged for placing the pyrolyzate adsorbent into a package (e.g., a gas storage vessel, a gas-impermeable bag, or another package). The enclosure may be supplied with inert (optionally and preferably oxygen-depleted) gaseous environment such as nitrogen, or one or more added gases conducive to the manufacturing process. The enclosure might also be equipped with active getters for controlling moisture, oxygen, or other another atmospheric impurity. The carbon pyrolyzate adsorbent may be placed into the package under a concentrated inert atmosphere (e.g., comprising at least 99 or 99.9 percent by volume of one or more of nitrogen, helium, argon, xenon, and krypton) or in a reducing atmosphere of hydrogen, hydrogen sulfide, or other suitable gas, or a combination of inert gas and reducing gas.

By another technique for reducing the presence of atmospheric impurities in a storage system, particularly as contained by materials of a vessel, the vessel, especially the vessel interior, may be prepared from a material that will reduce the presence of the atmospheric impurities at the vessel interior during use of the vessel. A vessel or other components of a storage system (e.g., valve) may be made of a material such as a metal, metal alloy, coated metal, plastic, polymer, or a combination thereof, that can be selected or processed to reduce the introduction of impurities into an interior of a storage vessel. A polished smooth, low surface roughness surface, e.g., vessel wall, can be less reactive with a reagent gas contained at a vessel interior, may adsorb less gas or moisture from its surroundings, and, therefore, may be preferred as an interior surface of a storage vessel as described. See WO 2017/079550 (e.g., at paragraphs [0028] and [0030]). Specific examples of useful or preferred materials of an interior of a storage vessel may be selected based on a type of adsorbent or reagent gas to be contained in the vessel. A high nickel metal alloy or a highly polished (low surface roughness) or coated metal or performance plastic may help minimize interaction and impurities, especially with halide gases as a stored reagent gas.

Alternately, or in addition, to further reduce the presence of atmospheric impurities in a storage system, particularly as contained by materials of a vessel, a vessel (of any material), before adding adsorbent, may be exposed to a heating and optional depressurization step to reduce the amount of impurities that may be contained within materials of the vessel, e.g., that are adsorbed in minute amounts within materials of the vessel, e.g., sidewalls and a bottom of the vessel, or within other components of a vessel or storage system such as a valve. A vessel or other components of the system may be made of a material such as a metal, metal alloy, coated metal, polished metal, plastic, polymer, or a combination thereof. Any of these materials may contain very small or minute amounts of adsorbed impurities such as moisture, another atmospheric impurity, or organic volatile materials.

A step of cleaning, drying, passivating, purging, or heating a vessel before adsorbent is added to and contained at the vessel interior may be performed by exposing a vessel or other components of a storage system, while the vessel does not contain adsorbent, to any suitable condition that will cause impurities that may be contained in the material to be dispelled (degassed) or otherwise removed from the material, e.g., due to high temperature, reduced pressure, by a chemical or physical mechanism, or otherwise. One or more of these steps may be performed before adding any adsorbent to the interior of the vessel.

A step of heating a vessel with optional reduced pressure, to remove adsorbed impurities from materials of the vessel or system, may be carried out in any effective manner, at a useful temperature and pressure, including a temperature at which the material of the vessel or system is thermally stable. Certain materials used for a vessel or storage system are less stable than others, and a temperature used during a heating step will be one at which a particular material remains stable and does not degrade. The heating step may be carried out in a progressive fashion involving temperature ramping from an ambient starting temperature to a desired elevated temperature, above that which the vessel should encounter during storage, transport, and use e.g., in a temperature range of from 110° C. to 300° Celsius, with the heating step being performed over a time that may variously range from 8 to 40 hours, as desired and effective. A preferred heating step may also be performed in an evacuated atmosphere, such as at a pressure of below 650 Torr, e.g., at a pressure of below 3 Torr, or below 1×10⁻⁴ Torr, or below 1×10⁻⁵ Torr.

As another specific technique for reducing the presence of atmospheric impurities in a storage system, particularly as contained by an adsorbent, an adsorbent may be subjected to a heating and depressurization step after the adsorbent is placed within a storage vessel, to reduce the amount of impurities present in the adsorbent. A heating step may be performed on adsorbent contained in a vessel by exposing adsorbent, and the vessel that contains the adsorbent, to any suitable heating and pressure conditions that will remove an amount of atmospheric impurities that may be contained in the adsorbent after placement of the adsorbent within the vessel, without producing an undue detrimental thermal effect on the adsorbent. The heating step is performed before adding any reagent gas to the adsorbent and vessel interior.

A step of heating adsorbent within a vessel to remove atmospheric impurities may be carried out at in any effective manner, at a useful temperature and pressure, including a temperature at which the adsorbent is thermally stable. Certain adsorbent materials are less stable than others, and a temperature used during a heating step will be one at which a particular adsorbent remains stable and does not degrade. The heating step may be carried out in a progressive fashion involving temperature ramping from an ambient starting temperature to a desired elevated temperature, e.g., in a temperature range of from 110° C. to 300° Celsius, with the heating step being performed over a time that may variously range from 8 to 40 hours, or longer, as desired and effective. A preferred heating step may be performed in an evacuated atmosphere, such as at a pressure of below 5 Torr, e.g., at a pressure of below 1×10⁻⁵ or 1×10⁻⁶ Torr.

A method as described may also involve a step of chemically passivating adsorbent, before or after the adsorbent is placed within the vessel. A chemical passivation step may include a step of exposing surface sites of adsorbent to a chemical, in the form of a gas (passivation gas), to remove residual adsorbed impurities (e.g., atmospheric impurities), or to neutralize or inactivate active surface sites on the adsorbent. The amount and type of passivation gas of a passivation step, and the amount of time of exposure of the passivation gas to the adsorbent, can depend on the type of the adsorbent, as well as the type of reagent gas that will be stored by adsorption onto the adsorbent.

As a single example, a step of chemically passivating adsorbent may be performed in a vessel that contains the adsorbent, by exposing the adsorbent to reagent gas that is the same reagent gas that will be charged to the vessel in a subsequent filling step; i.e., the reagent gas that will be stored in the vessel is used as the passivating gas in a step of passivating the adsorbent. The adsorbent may be exposed to the reagent gas at any pressure and for any amount of time that will passivate the adsorbent, chemically, by reacting with active surface sites on the adsorbent to inactivate those sites, prior to the vessel being charged with the same reagent gas for the purpose of storing the reagent gas within the vessel. Optionally, the adsorbent may be exposed to a reagent gas as a passivation gas at elevated pressure but low concentration in an inert, non-reactive gas, such as diluted to a concentration of 2, 5, or 10 percent (by volume) and pressurized to 1,000, 2,000, or 5,000 Torr.

For example, in a chemical passivation step, the adsorbent may be exposed to the reagent gas at a relative low pressure, e.g., a pressure of below 760 Torr, such as a pressure in a range from 1, 2, 5, or 10 Torr, up to 50, 100, 200, or 500 Torr. The time of exposure of the adsorbent to the passivation gas can be any useful amount of time, for example a time in a range from 15 to 2500 minutes, e.g., from 60 to 1000 minutes. A passivation step may be carried out at ambient temperature, or at elevated temperature, e.g., a temperature in a range from 60 to 300 degrees Celsius, e.g., from 85 to 250 degrees Celsius. After a desired time of exposure of the adsorbent to the passivation gas, the passivation gas is removed from the adsorbent by exposure to reduced pressure, for example to a pressure of less than 3 Torr, e.g., a pressure of below 1×10⁻⁵ or 1×10⁻⁶ Torr.

According to another optional step of treating the adsorbent to reduce the amount of atmospheric impurities present in the adsorbent, the adsorbent may be contacted with a “displacing gas,” optionally with elevated pressure and temperature, and optionally through multiple cycles of the exposure, to cause impurities to be removed from the adsorbent into the displacing gas. By this step, adsorbent is contacted with the displacing gas in a manner that is effective to displace impurities from the adsorbent, and the displacing gas is then removed from the adsorbent, to yield adsorbent that contains a lower amount of the atmospheric impurities. Pressure and temperature can be controlled and may be elevated and optionally modulated, i.e., cycled between a higher and lower pressure or a higher and lower temperature.

The displacing gas may be an inert gas such as one or a combination of nitrogen, helium, argon, xenon, or krypton. Alternately, the displacing gas may be a reducing gas such as hydrogen or hydrogen sulfide, or a combination of an inert gas and a reducing gas, such as a mixture of approximately 5 percent (volume) hydrogen in a balance of nitrogen.

After desired steps of preparing adsorbent and placing the adsorbent at an interior of a storage vessel, while treating the adsorbent as described to reduce or minimize the amount of atmospheric impurities to which the adsorbent is exposed or contains, the vessel can be filled (“loaded” or “charged”) with reagent gas to a desired pressure, with the reagent gas being introduced into the vessel interior, resulting in the reagent gas adsorbing onto the adsorbent.

To reduce or control the amount of atmospheric impurities that will become present in the vessel, i.e., that may be added to the vessel or reagent gas during a step of charging reagent gas to the vessel, various steps can be performed on the vessel and adsorbent during a filling (charging) step, and certain filling equipment can be used during a filling step. These include, generally, any one or more of: the use of reagent gas of the highest possible purity or, alternately, purifying the reagent gas prior to introduction into the storage vessel; use of filling equipment that is processed, handled, and used in a manner that reduces exposure of the equipment (especially interior spaces) to atmospheric gases or to more than a single reagent gas; steps of a filling process that may be effective to remove atmospheric impurities from filling equipment and from a vessel either during or after adding the reagent gas to the vessel; any of which may be useful alone or in combinations of two or more of these.

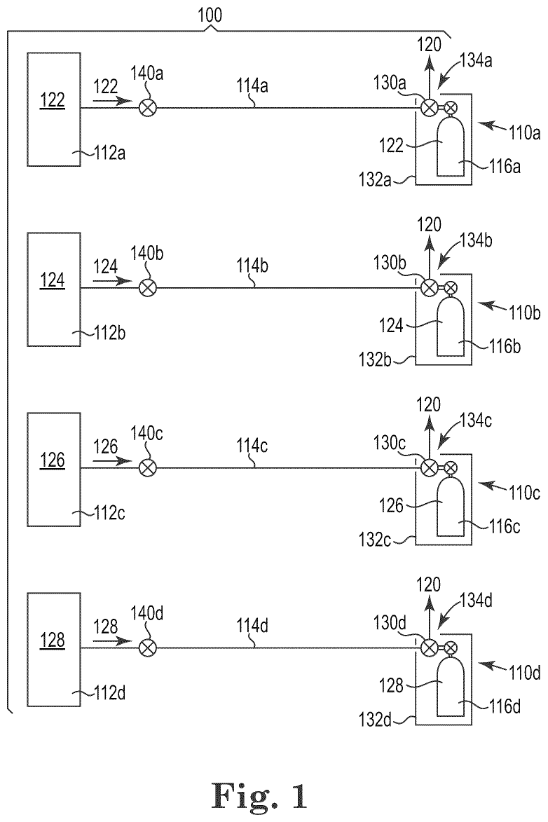

As an example, FIG. 1 shows a non-limiting example of a system 100 that includes individual fill stations 110a, 110b, 110c, and 110d, each having its own reagent gas source (112a, 112b, 112c, and 112d) and conduits (114a, 114b, 114c, and 114d) (including multiple valves, as illustrated). In use, each reagent gas source contains a different reagent gas (122, 124, 126, 128), and each individual conduit 114 (a, b, c, or d) is used to flow only a single type of reagent gas to fill a receiving vessel (116a, 116b, 116c, or 116d).

Each fill station also includes a temperature monitoring and control system (e.g., jacket) 132a, 132b, 132c, and 132d, that is effective to precisely monitor and control the temperature of the receiving vessel and its contents during a fill step. Each fill station also includes a pressure monitoring and control system that is effective to precisely monitor and control the internal pressure of the receiving vessel during a fill step. Example fill stations can include a temperature control system that is capable of monitoring and controlling a temperature of a receiving vessel, a reagent gas as it enters the receiving vessel during a fill step, or the contents (reagent gas, adsorbent, or both) of a receiving vessel during a fill step, relative to a desired setpoint temperature, to a temperature that is within a range that is greater than or less than the setpoint temperature by not more than 3 degrees C., e.g. that is greater than or less than the setpoint temperature by not more than 1 or 0.5 degree C.

Each station can be dedicated, at least for useful or large number of fill cycles (one cycle fills one vessel 116), e.g., at least 100, 500, or 1000 fill steps (a single fill step will fill one storage vessel with reagent gas), to fill only one specific type of reagent gas to a receiving vessel. Use of a fill station with a single reagent source, i.e., to fill only one type of reagent gas in storage vessels, over extended use of the fill station, can be effective to avoid undue exposure of the station and relevant conduits to environmental impurities during changeover from one reagent gas to a different reagent gas. Dedicated fill stations also reduce the potential for cross-contamination of different types of reagent gases between storage vessels filled by the station.

Likewise, to prevent the potential for cross-contamination between receiving vessels, each fill station can optionally (as illustrated) include only a single reagent gas source 112 (a, b, c, or d) and only a single outlet 134 (a, b, c, or d) to which a receiving vessel (116a, b, c, or d) can be connected to flow reagent gas (122, 124, 126, or 128) from the gas source, using the fill station, into the receiving vessel.

Optionally, independently for each one, or all of, fill stations 110a, 110b, 110c, and 110d, interior surfaces of conduit 114a, 114b, 114c, or 114d, or any surface that contacts a reagent gas during a fill step, can be made of a material such as a metal, metal alloy, coated metal, plastic, polymer, or a combination thereof, that can be selected or processed to avoid the introduction of impurities from the surface to the reagent gas during flow of the reagent gas past the surface. A polished smooth, low surface roughness surface of a conduit can be less reactive with a reagent gas that flows through the conduit, will adsorb less gas or moisture from its surroundings, and may be preferred as an interior surface. See WO 2017/079550 (e.g., at paragraphs [0029] and [0030]. Specific examples of useful or preferred materials of an interior of a conduit may be selected based on a type of adsorbent or reagent gas to be contained in the vessel. A high nickel metal alloy or a highly polished (low surface roughness) or coated metal or performance plastic may help minimize interaction and impurities with halide gases.

To further eliminate environmental impurities, a purge valve (130a, 130b, 130c, and 130d) is present in a conduit of each fill station. The purge valve can be useful for purging the conduit between fill cycles, before a fill cycle, or after a period (e.g., at least 2, 4, 6, or 8 hours) of non-use of the fill station during which a volume of reagent gas was not flowed through the conduit, e.g., was held in place in the conduit without flowing through the conduit.

The purge valve may optionally connect directly to a scrubber or other type of reagent gas waste receptacle, and can be opened immediately before a fill step to allow the amount of reagent gas that is present in a conduit to be purged (sent to the scrubber or waste receptacle), such that the reagent gas that becomes added to the receiving vessel (116a, b, c, or d) is reagent gas that had been stored in the reagent gas source (112a, 112b, 112c, or 112d), and had not resided (or rested) for an amount of time in the conduit (114a, 114b, 114c, or 114d). The amount of reagent gas that is released from the conduit during this purge step may be at least a volume of the reagent gas that is approximately equal to the volume of the conduit that extends between a reagent gas source (112a, 112b, 112c, or 112d) and the purge valve (130a, 130b, 130c, or 130d).

Alternately or additionally, to still further eliminate environmental impurities, reagent gas may flow through the conduit of the fill station at a relatively low gas pressure, flow rate, or both.

A low reagent gas pressure within conduits and flow channels of a filling system can be effective to minimize or slow reaction of the reagent gas flowing through the conduit or system, with any reaction sites available at the interior surfaces of the conduit or system. Example pressures of reagent gas in a conduit may be below 50 pounds per square inch (gauge) (psig), such as below 25 or 15 psig.

Also, additionally or alternately, to reduce the presence of environmental impurities that become present in a reagent gas stored in and delivered from the vessel, a fill step can be performed using a relatively low flow rate of the reagent gas through a filling system (e.g., conduit thereof) and into the vessel, to achieve a relatively slow increase in gas pressure within the receiving vessel, while filling the vessel with the reagent gas.

Examples of useful flow rates of reagent gas through a filling system, e.g., conduit thereof, and into a receiving vessel, may be a flow rate of below 1000 standard cubic centimeter per minute (sccm), e.g., below 500 sccm or below 250 sccm. This may be the flow of the reagent gas at an outlet of a fill system, at the point of the reagent gas exiting the fill station and being flowed into the storage vessel.

Examples of a useful rate of pressure increase of reagent gas flowing into a storage vessel may be a pressure increase within the vessel that is below 100 Torr per hour, e.g., below 1 torr per minute, or below 0.5 Torr per minute.

A slow rate of fill or a slow rate of pressure increase may reduce impurities generated during a fill step, that may be introduced to the reagent gas during a fill step, theoretically, because a slow and controlled filling rate is believed to prevent spikes in pressure and temperature of the system or individual components of the system (the vessel, reagent gas, and adsorbent media) due to heat of adsorption that might increase a reaction rate or reactivity between. In somewhat more detail, filling the storage vessel directly with a predetermined maximum fill capacity of reagent gas would cause significant adsorptive heating of the adsorbent and the reagent gas, and result in a fairly rapid increase of vessel interior pressure that would be much higher than targeted, that would eventually drop back down as the adsorbent cools and the adsorption capacity returns. By using a low flow rate and slow rate of filling the storage vessel, a rapid increase (spike) in temperature, pressure, or both, within the storage vessel, can be avoided or minimized. Avoiding an undue increase in temperature, pressure, or both, of the adsorbent and reagent gas within the vessel, can control or reduce the degree of reaction between the reagent gas, vessel, and media (adsorbent) while the reagent gas is added to the storage vessel interior.

Using a system such as system 100 of FIG. 1, or using an individual fill station (e.g., 110a) illustrated at FIG. 1, a fill step that flows reagent gas into a receiving vessel may be performed with a cycle that includes: adding reagent gas to the vessel (to a desired internal pressure); after flow of reagent gas into the vessel is stopped, at a desired pressure, resting the vessel to allow the vessel interior pressure to reach an equilibrium (by reagent gas adsorbing to or desorbing from adsorbent); and, after achieving equilibrium, removing (purging) an amount of the reagent gas from the vessel interior, e.g., from headspace of the vessel interior, which results in a reduced pressure at the vessel interior. After purging, the vessel can be allowed to reach a second (adjusted) equilibrium with the reduced amount and pressure of reagent gas at the interior.

According to example methods, with reference to FIG. 1, with the conduit initially containing reagent gas from the reagent gas source, and the valve (140a, 140b, 140c, or 140d) to the reagent gas source being open, the conduit (e.g., 114a) of a fill station (e.g., 110a) can be first purged by release of reagent gas through valve 130a, in an amount (volume) that equals or exceeds a volume of space defined within conduit 114a. Reagent gas (e.g., 122) is then slowly, at low pressure, flowed from reagent gas source (e.g., 112a), through conduit (e.g., 114a), into the receiving vessel (e.g., 116a), which contains adsorbent, and which is precisely maintained at a desired setpoint temperature, e.g., within 1 degree Celsius above or 1 degree Celsius below the setpoint temperature. A slow fill rate (flow rate of reagent gas into the receiving vessel), with a slow rate of pressure increase at the vessel interior, can result in reduced atmospheric impurities being released into the receiving vessel because the slow fill rate can reduce the level of reactivity between reagent gas, vessel, and adsorbent media, by avoiding rapid increases in temperature and pressure (i.e., temperature or pressure “spikes”) within the vessel during a fill step.

In an example method, the reagent gas is added to the receiving vessel in an amount to exceed a use pressure (a.k.a. “target pressure” or “final fill pressure”) of the storage vessel, i.e., an initial pressure of the vessel when the vessel contains an amount of the reagent gas for use of the vessel to store, transport, and selectively release the reagent gas from the vessel for use. The internal pressure of the vessel, which may be greater than the use pressure, at this initial stage of the fill process, can be a pressure that is expected to be the maximum pressure that the vessel will encounter during storage, transport, and use of the vessel, when filled with the reagent gas, or a pressure below that pressure and above the use pressure. For a vessel that is designed to contain reagent gas at sub-atmospheric pressure, an example of the internal pressure of the vessel with the reagent gas added in an excess amount as described, may be a pressure of at least 760, 1000, or 1200 Torr. For example, with a target pressure (final fill pressure) of 650 Torr, the vessel may initially be filled to a range from 700 Torr to 1000 Torr, e.g. greater than 760 Torr or greater than 800 Torr, and allowed to equilibrate before being pumped back down to the target 650 Torr.

Measured differently, an example of an internal pressure of a vessel (designed for sub-atmospheric storage of reagent gas) with reagent gas added in an excess amount, as described, may be a pressure of at least 10, 20, or 50 percent higher than a target pressure (“use pressure”). E.g., if the vessel will contain reagent gas at a pressure of 760 Torr during use (the “use pressure,” meaning pressure of the vessel when the vessel is filled with the reagent gas for storage, transportation, and selective delivery of the reagent gas), the vessel can be filled in this step with excess reagent gas to achieve an internal pressure that is 10, 20, or 50 percent greater than the 760 Torr “use pressure,” i.e., to an internal pressure that is 836 Torr, 912 Torr, or 1,140 Torr, respectively.

After adding the reagent gas in the excess amount, the vessel is allowed to equilibrate, meaning that an amount of reagent gas adsorbed on the adsorbent, and an amount of gaseous reagent gas present as a gas in headspace volume of the vessel, come to a thermodynamic equilibrium. After adding the reagent gas in an excess amount, the vessel is held (e.g., at constant temperature) for an amount of time that is sufficient to achieve the equilibrium, with the gaseous reagent gas that is contained as a gas in the headspace potentially containing an amount of atmospheric impurities that passed from the adsorbent to gaseous reagent gas of the headspace. The reagent gas in the headspace, with the contained impurities, can then be released from the vessel to remove the impurities and to bring the vessel to a lower content of the reagent gas and to a lower pressure, e.g., to a reagent gas content and to an initial pressure as are intended for the purpose of transporting and storing the reagent gas within the vessel, e.g., a “target pressure” or a “use pressure.”

The amount of time required to reach the described equilibrium after adding the reagent gas in the excess amount may vary depending on factors such as: the type of adsorbent; the type of reagent gas; the amount of adsorbent relative to total volume of the vessel and the volume of headspace in the vessel; the amount of reagent gas added to the vessel; and the pressure at the interior of the vessel. Example amounts of time after adding the reagent gas to the described excess pressure and releasing an amount of the reagent gas with impurities, may be an amount of time in a range from 30 minutes to 1000 hours, e.g., from 1 hour to 500 hours, such as from 2 hours to 100 hours.

Still other, alternate or additional measures may be useful to control the amount of atmospheric contaminants that may be introduced to a reagent gas during filling, by controlling exposure of gas handling and filling equipment (e.g., a gas handling and filling manifold) to atmospheric gases, e.g., to the ambient atmosphere (“room air” that is present in the immediate environment of the system). These measures can include a check valve located at an outlet of a system (e.g., at outlet 134a, b, c, or d) of FIG. 1. A check valve can effectively prevent back backward flow (or “backflow”) of ambient atmosphere (room air) into a conduit line of the filling system when a storage vessel is removed or replaced (engaged or disengaged with the system) at the location of the outlet.

Alternately or additionally, sustaining a low level of flow (“trickle purge”) of inert gas through a conduit or other component of a filling system can be maintained at any time a seal is broken in the gas handling system, e.g., any time when the internal space of the system (e.g., a conduit) is exposed fluidically to ambient air or “room air.” In this manner, the inert gas continuously sweeps through the conduit and other flow control structures of the system and minimizes the diffusion of atmosphere (room air) back into the lines at any opening. For instance, a flow of ultra-high purity nitrogen at or above 50 sccm, or a flow of 25 sccm of pure helium, can be used to minimize air entry into interior locations of the system.

Optionally or additionally, reagent gas handled by the gas filling system and delivery manifold (outlet) can be passed through a in-line gas purifier just prior to entry into the receiving adsorbent-filled storage vessel. In this manner any contaminants (atmospheric impurities) that may have been introduced into the system (e.g., conduit, control devices, etc.) can be removed down to the ppb (part per billion) level before the reagent gas enters the vessel. Such point-of-use purifiers can be designed for the specific reagent gas being handled by those practiced in the art. Such purifiers can be filled with highly selective adsorbents or molecular sieve materials for selective removal of contaminants, e.g., atmospheric impurities, at the point of filling.

At a time of adding the reagent gas to the vessel, or at a time when the reagent gas is introduced to a fill station, the reagent gas can be in a highly pure state, including that the reagent gas can contain very low amounts of atmospheric gases as impurities.

Example hydride reagent gases, when initially loaded into a storage vessel (that contains adsorbent), or when included as a raw material of a fill station (e.g., as contained in a reagent gas source 112a of FIG. 1), can contain a level of atmospheric impurities that is below about 2 ppmv for each of as nitrogen (N₂), carbon monoxide (CO), carbon dioxide (CO₂), methane (CH₄), and water vapor (H₂O), measured individually. The reagent gas may contain a less than 5 ppmv of a total amount of nitrogen (N₂), carbon monoxide (CO), carbon dioxide (CO₂), methane (CH₄), and water vapor (H₂O). A preferred hydride gas source may contain lower levels of each one of these individual atmospheric impurities, for example a maximum amount of each one of the individual listed impurities that is below 1 ppmv, or below 0.5 or 0.2 ppmv. A preferred hydride gas source may contain a total amount of these impurities (combined) that is below 1 ppmv, or below 0.5 or 0.2 ppmv.

Useful, acceptable, or preferred amounts of these impurities, individually or as a total, may be different for fluoride gases as the reagent gas. For fluoride reagent gases, when loaded into adsorbent contained in a storage vessel, or as a reagent source of a fill station (e.g., 112 of FIG. 1), a maximum amount of each one of the individual atmospheric impurities can preferably be below about 10 ppmv for each of as nitrogen (N₂), carbon monoxide (CO), carbon dioxide (CO₂), methane (CH₄), and water vapor (H₂O), measured individually. The reagent gas may contain a less than 50 ppmv of a total amount of nitrogen (N₂), carbon monoxide (CO), carbon dioxide (CO₂), methane (CH₄), and water vapor (H₂O). A preferred fluoride gas source may contain lower levels of each one of these individual atmospheric impurities, for example a maximum amount of each one of the individual listed impurities that is below 2 ppmv, e.g., below 1 ppmv. A preferred fluoride gas source may contain a total amount of these atmospheric impurities (combined) that is below 4 ppmv, or below 3 or 2.5 ppmv.

The amounts of individual atmospheric impurities, and an amount of all (total) atmospheric impurities in reagent gas before the reagent gas is added to the vessel, or when the reagent gas is introduced to a fill station for loading to the vessel (e.g., as contained in a reagent gas source 112), will be lower than the amounts present in the reagent gas after adsorption and desorption on adsorbent, inside a vessel, and upon delivery of the reagent gas from the storage vessel. Additional atmospheric impurities are introduced to the reagent gas during the process of handling, processing, moving, and packaging the reagent gas to produce a packaged supply of the reagent gas.

Methods, techniques, and equipment of the present description attempt to reduce or minimize the amount of atmospheric impurities to which a reagent gas is exposed during a fill step, such as between a time that is at or before the reagent gas being added to a storage vessel (e.g., from when the reagent gas is contained in reagent gas source 112a of fill station 110a of FIG. 1), to when the reagent gas is contained in (for storage) and selectively delivered for use from the vessel. The present description recognizes that the amount of atmospheric impurities contained in a reagent gas selectively delivered from a storage vessel, after storage within the vessel, can be reduced by using techniques and equipment that are designed to present a reduced or minimum amount of these impurities to the reagent gas from the vessel itself, from the adsorbent, and from equipment and handling techniques that are used to transfer the reagent gas from a bulk source of the reagent gas (e.g., source 112a, b, c, or d of FIG. 1) into individual storage vessels in which the reagent gas can be stored, transported, and then selectively released for use.

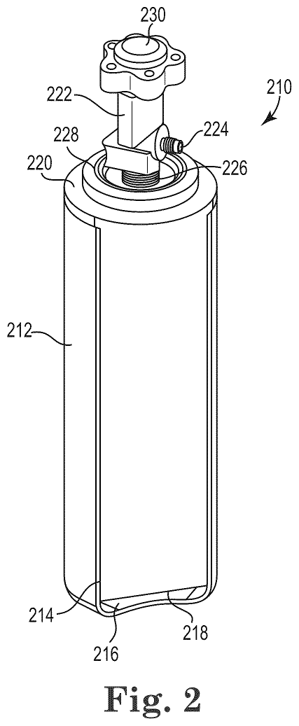

FIG. 2 is a perspective cut-away view of a fluid supply system (package) of the present disclosure, in which adsorbent is contained in a vessel for reversible storage of fluid (reagent gas) thereon.

As illustrated, fluid supply system 210 includes vessel 212, which has cylindrical sidewall 214, and a floor at the bottom of the sidewall. The sidewall and floor enclose an interior volume 216 of the vessel in which is disposed adsorbent 218. Adsorbent 218 is of a type having sorptive affinity for a desired reagent gas, and from which the reagent gas can be desorbed under dispensing conditions for discharge (release, dispensing) from the vessel. Vessel 212 at its upper end portion is joined to a cap 220, which may be of planar character on its outer peripheral portion, circumscribing the upwardly extending boss 228 on the upper surface thereof. Cap 220 has a central threaded opening receiving a correspondingly threaded lower portion 226 of the fluid dispensing system. While these particular structures are suitable and useful for a vessel as described and supply system as described, other alternative structures for a vessel and related structures of a supply system will be known and useful as alternatives to those illustrated at FIG. 2.

Fluid dispensing system 210 includes valve head 222 in which is disposed a fluid dispensing valve element (not shown in FIG. 2) that is translatable between fully open and fully closed positions by action of the manually operated hand wheel 230 coupled therewith. The fluid dispensing system includes outlet port 224 for dispensing fluid from the vessel when the valve is opened by operation of the hand wheel 230. In lieu of the hand wheel 230, the fluid dispensing system may comprise an automatic valve actuator such as a pneumatic valve actuator that is pneumatically actuatable to translate the valve in the fluid dispensing system between fully open and fully closed positions of the valve.

Outlet port 224 is defined by the open end of a corresponding tubular extension communicating with a valve chamber in valve head 222, containing the translatable valve element. Such tubular extension may be threaded on its outer surface, to accommodate coupling of the fluid dispensing system to flow circuitry for delivery of dispensed fluid to a downstream locus of use, e.g., a reagent gas-utilizing tool adapted for the manufacture of a semiconductor manufacturing product such as an integrated circuit or other microelectronic device, or a reagent gas-utilizing tool adapted for manufacture of solar panels or flat-panel displays. In lieu of a threaded character, the tubular extension may be configured with other coupling structure, e.g., a quick-connect coupling, or it may otherwise be adapted for dispensing of fluid to a locus of use.

Adsorbent 218 at interior volume 216 of vessel 212 may be of any suitable type as described herein and may for example be or contain adsorbent in a powder, particulate, pellet, bead, monolith, tablet, or other appropriate or useful form. The adsorbent is selected to have sorptive affinity for a reagent gas of interest that is to be stored in the vessel during storage and transport conditions, and selectively dispensed from the vessel under dispensing conditions. Such dispensing conditions may for example include opening of the valve element in the valve head 222 to accommodate desorption of fluid (reagent gas) that is stored in an adsorbed form on the adsorbent, and discharge of same from the vessel through the fluid dispensing system to outlet port 224 and associated flow circuitry, wherein the pressure at the outlet port 224 causes pressure-mediated desorption and discharge of fluid from the fluid supply package. For example, the dispensing assembly may be coupled to flow circuitry that is at lower pressure than pressure at the interior of the vessel for such pressure-mediated desorption and dispensing, e.g., a sub-atmospheric pressure appropriate to a downstream reagent gas-utilizing tool coupled to the fluid supply package by the aforementioned flow circuitry.

Alternatively, dispensing conditions may include opening of the valve element in the valve head 222 in connection with heating of the adsorbent 218 to cause thermally-mediated desorption of fluid (reagent gas) for discharge from the fluid supply package. Any other alternative or additional desorption-mediating conditions and techniques may also be used, as desired, or any combination of such conditions and techniques.

Fluid supply package 210 (adsorbent-type storage system) may be charged with fluid for storage on the adsorbent by any fill method, to a desired pressure, which may be sub-atmospheric or super-atmospheric. Fluid may be passed through outlet port 224 to fill the interior. Alternatively, the valve head 222 may be provided with a separate fluid introduction port for charging of the vessel.

Fluid (reagent gas) in the vessel may be stored at any suitable pressure conditions. An advantage of using adsorbent as a fluid storage medium is that fluid may optionally be stored at low pressure, e.g., sub-atmospheric pressure or low super-atmospheric pressure, thereby enhancing the safety of the fluid supply package relative to fluid supply packages that store reagent gas at a high pressure, as do high pressure gas cylinders.

The fluid supply package of FIG. 2 may be used in conjunction with any adsorbent as described herein, to provide an effective storage medium for a packaged reagent gas, and from which the reagent gas can be selectively desorbed under dispensing conditions for supply of the reagent gas to a particular locus of use or to a particular reagent gas-utilizing apparatus. The reagent gas may be delivered from the vessel for use at a dispensing condition, for use of the reagent gas in a manufacturing process. The process may be for processing semiconductor materials or microelectronic devices, with example processes including: ion implantation, expitaxial growth, plasma etching, reactive ion etching, metallization, physical vapor deposition, chemical vapor deposition, atomic layer deposition, plasma deposition, photolithography, cleaning, and doping, among others.

The reagent gas may be one that is delivered for use in a process of manufacturing semiconductor products, flat-panel displays, solar panels, or components or subassemblies thereof. The reagent gas may be any type of reagent gas useful as a raw material for one of these processes, such as: silane, disilane, germane, boron trifluoride, phosphine, arsine, diborane, acetylene, germanium tetrafluoride, silicon tetrafluoride, or another useful reagent gas. The reagent gas may also include a combination of two or more different gases, such as germanium tetrafluoride and hydrogen gas (H₂), boron trifluoride and hydrogen gas, among others.

According to useful and preferred storage systems as described, and described methods and equipment used for preparing the storage systems, a vessel prepared to contain reagent gas by techniques as described is capable of dispensing the reagent gas to contain a substantially lower amount of atmospheric impurities compared to previous commercial adsorbent-type storage systems. For example, useful storage systems as described may be capable of delivering reagent gas that contains a total amount of atmospheric impurities that is below 150 ppmv, e.g., below 50 ppmv, or less than 25, 15, or less than 10 ppmv, measured as a total (combined) amount of nitrogen (N2), carbon monoxide (CO), carbon dioxide (CO₂), methane (CH₄), and water vapor (H2O). Useful and preferred storage systems may be capable of delivering reagent gas that also exhibits a low level of each of these atmospheric impurities measured individually, e.g., delivering reagent gas that contains less than 25, 20, 15, 20, or 5 ppmv (measured individually) of each of: nitrogen (N₂), carbon monoxide (CO), carbon dioxide (CO₂), methane (CH₄), and water vapor (H₂O).

A reagent gas stored in a vessel as described, which can be delivered to contain a relatively lower amount of atmospheric impurities compared to other storage systems, can result in improved performance of a semiconductor processing apparatus (“tool”) based on the lower level of those impurities.

Certain types of impurities in reagent gases delivered to a tool can produce cross-contamination due to minimal or inadvertent communication between sources of reagent gases within a tool. Systems and methods as described can control or minimize cross contamination between reagent gases between storage vessel that are processed and filled using a filling system as described, e.g., that includes dedicated fill stations as shown at FIG. 1. Such systems are effective to reduce the likelihood of cross-contamination of different types of reagent gases, between filled storage vessels. Controlling or reducing cross-contamination in this manner will improve performance of systems that use a reagent gas that has been filled and stored in a storage vessel in a manner presently described.

As one example of a detrimental effect of cross-contamination, of reagent gases between filled storage vessels, cross-contamination of one reagent gas in a storage vessel of a desired (different) reagent gas used for ion implantation, can have a detrimental effect on the process, particularly on the make of the ion beam produced, as may be evident in a beam spectrum analysis. The beamline of an ion implanter separates ionic species by atomic mass unit (amu) via magnetic acceleration through the curved path to the tool. The beam is controlled to deliver a specific amu species to a wafer surface for implantation. If contaminants (cross-contaminants from another storage vessel filled using a storage system) in a reagent gas are too close in amu to a desired species, a contaminant isotopic species (e.g., carbon-12, 12C) may not be separated from a desired isotopic species (e.g., boron-11, 11B) during an ion implantation step, and the contaminant isotopic species may become present in an ion beam along with the desired isotopic species, and would then inadvertently become implanted into the wafer. Carbon of amu 12 could be a problematic contaminant for a beam tuned to deliver boron amu 11.

1. A process for storing and delivering a reagent gas comprising:
transferring a pyrolyzed adsorbent to an interior of a gas storage vessel within an inert environment without exposing the pyrolyzed adsorbent to ambient atmosphere;
exposing the pyrolyzed adsorbent contained within the interior of the gas storage vessel to elevated temperature and reduced pressure to remove residual moisture and volatile impurities;
introducing a reagent gas into the gas storage vessel, the reagent gas becoming adsorbed onto the pyrolyzed adsorbent; and
storing the reagent gas within the gas storage vessel.

2. The process of claim 1, wherein the dispensed reagent gas contains one or more of: less than 25 parts per million by volume CO, less than 25 parts per million by volume CO₂, less than 25 parts per million by volume N₂, less than 25 parts per million by volume CH₄, or less than 25 parts per million by volume H₂O.

3. The process of claim 1, wherein the dispensed reagent gas contains less than 25 parts per million by volume CO, less than 25 parts per million by volume CO₂, less than 25 parts per million by volume N₂, less than 25 parts per million by volume CH₄, and less than 25 parts per million by volume H₂O.

4. The process of claim 1, wherein the pyrolized adsorbent is at a temperature of at least 40 degrees Celsius when transferred to the interior of the gas storage vessel.

5. The process of claim 1, further comprising heating the gas storage vessel to elevated temperature, at a reduced pressure, before adding the pyrolyzed adsorbent to the vessel, to remove adsorbed impurities from walls of the vessel.

6. The process of claim 1, wherein exposing the adsorbent at the vessel interior to elevated temperature and reduced pressure comprises exposing the adsorbent contained in the vessel to:
an elevated temperature in a range from 110 to 300 degrees Celsius,
at a pressure below 1×10⁻⁵ Torr,
for a period of time in a range from 8 to 40 hours, to remove one or more impurity selected from CO, CO₂, N₂, CH₄, and H₂O from the adsorbent.

7. The process of claim 1, further comprising:
passivating the adsorbent by contacting the adsorbent with passivating gas that comprises the reagent gas, and
removing the passivating gas from the adsorbent after an amount of time effective to passivate the adsorbent, and
after the passivation step, adding the reagent gas to the vessel interior.

8. The process of claim 1, further comprising:
introducing the reagent gas to the interior of the gas storage vessel in an amount sufficient to produce pressure (Torr, absolute) at the vessel interior that is at least 10 percent greater than a target pressure,
allowing the reagent gas at the pressure to equilibrate between adsorbed reagent gas adsorbed on the adsorbent and gaseous reagent gas contained in headspace of the vessel, and
after allowing the reagent gas to equilibrate, removing a portion of the reagent gas to reduce the pressure at the interior to the target pressure.

9. The process of claim 1, further comprising dispensing the reagent gas from the vessel, the dispensed reagent gas containing less than 50 parts per million by volume of a total amount of impurities selected from CO, CO2, N2, CH4, and H2O, and combinations thereof.

10. The process of claim 1, wherein the adsorbent is in the form of granules, particulates, beads, pellets, or shaped monolith.

11. The process of claim 1, wherein a pressure of the interior of the gas storage vessel is below 760 Torr.

12. The process of claim 1, wherein the reagent gas is a hydride or a halide.

13. The process of claim 12, wherein:
the hydride is selected from arsine, silane, germane, methane, and phosphine, and
the halide is selected from BF₃, SiF₄, PF₃, PF₅, GeF₄, and NF₃.

14. A reagent gas dispensed from a gas storage vessel made according to the process of claim 1, the reagent gas comprising less than 50 parts per million by volume of a total amount of impurities selected from CO, CO2, N2, CH4, and H2O, and combinations thereof.

15. The reagent gas of claim 14, wherein the reagent gas is a hydride or a halide.

16. The reagent gas of claim 15, wherein:
the hydride is selected from arsine, silane, germane, methane, and phosphine, and
the halide is selected from BF₃, SiF₄, PF₃, PF₅, GeF₄, and NF₃.
